(19) United States
(12) Patent Application Publication
(10) Pub. No.: US 2002/0130608 A1
(43) Pub. Date: Sep. 19, 2002

(54) Color cathode ray tube employing a halo-reduced electron gun

(76) Inventor: Tsutomu Toujou, Mobara (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/096,489

(22) Filed: Mar. 13, 2002

(30) Foreign Application Priority Data
Mar. 14, 2001 (JP) 2001-072059

(51) Int. Cl. H01J 29/51

(52) U.S. Cl. 313/452

(57) ABSTRACT

A color cathode ray tube includes three in-line coplanar cathodes, a control electrode, an accelerating electrode, a focus electrode, and an anode. The control electrode is provided with three first-type electron beam apertures arranged in the in-line direction, each being elongated in the in-line direction. An end of the accelerating electrode facing the control electrode is provided with three through-hole electron beam apertures arranged in the in-line direction, each being superposed with a slit-shaped recess elongated in the in-line direction. An end of the focus electrode is provided with three non-axially-symmetric electron beam apertures arranged in the in-line direction, each having a major axis thereof in a direction perpendicular to the in-line direction.

### BACKGROUND OF THE INVENTION

The present invention relates to a color cathode ray tube used in a television receiver set or a color display device, and in particular to a color cathode ray tube employing an electron gun capable of reducing brightness of halos occurring in electron beam spots at the peripheries of the viewing screen, and thereby providing displays with good resolution when viewed from proper distances.

Color cathode ray tubes comprises at least an electron gun including cathodes, focus electrodes and accelerating electrodes with a main lens formed in its final stage, a phosphor screen and a deflection device, and they are widely used as high-quality display devices.

In these kinds of color cathode ray tubes, the following conventional techniques are known for obtaining good reproduced images in an area of the phosphor screen ranging from its center portion to its peripheral portions.

Japanese Patent Publication No. Sho 53-18,866 (published on Jun. 17, 1978) discloses provision of an astigmatic lens in a focus-lens-forming region formed by the second and third electrodes of an electron gun.

In a three-beam in-line type electron gun for emitting three electron beams along initially coplanar paths and thereafter focusing and accelerating the three electron beams, Japanese Patent Application Laid-Open No. Sho 51-64,368 (laid open on Jun. 3, 1976) elongates electron beam apertures in the first and second electrodes in a direction (hereinafter the vertical direction) perpendicular to the direction (hereinafter the horizontal direction) of the in-line arrangement of the three electron beams, and makes the two electron beam apertures different in shape from each other, or makes the ratio of the vertical diameter to the horizontal diameter of the aperture for the center electron beam smaller than that for the side electron beams.

Japanese Patent Application Laid-Open No. Sho 60-81,736 (laid open on May 9, 1985) projects the three electron beams on the phosphor screen via at least one non-axially-symmetric lens and includes one non-axially-symmetric lens formed by making slits in a cathode-side end of the third electrode of the in-line type electron gun such that the depth in the direction of the tube axis of the slit for the center electron beam is greater than that of the slits for the side electron beams.

Japanese Patent Application Laid-Open No. Hei 4-249,837 employs a plurality of non-axially-symmetric lenses.

### SUMMARY OF THE INVENTION

The above conventional techniques aims at improving uniformity in display quality by suppressing the amount of halos occurring in electron beam spots at peripheries of the viewing screen formed by the phosphor screen. However, it is very difficult to eliminate the halos completely by using the above-explained conventional techniques, and more or less halos remain. On the other hand, even if the halos are eliminated completely, the electron beam spot at the center of the viewing screen produces the so-called blooming, resulting in deterioration of resolution at the center of the viewing screen. Incidentally, a halo is a region of low current density in cross section of an electron beam occurring about a central region (called a core) of high current density in cross section of the electron beam, and the halo causes blur in an electron beam spot formed on the phosphor screen.

In the above-explained conventional technique, the electron beam apertures in the first or second electrode of an electron gun is elongated in the direction of the arrangement of the three in-line electron beams, and this configuration is intended to obtain good resolution at low currents.

The present inventor has found out that, especially in electron guns used in cathode ray tubes such as color cathode ray tubes for TV receivers and operated with a cathode current having a peak value in the range of from 3 mA to 4 mA, occurrence of halos can be suppressed and brightness of halos is reduced by superposing a horizontally-elongated slit-shaped recess (a recess formed by thinning a plate electrode in a portion of a region surrounding an electron beam aperture) on an electron beam aperture in an end of the second electrode facing the first electrode of an electron gun, and at the same time configuring an end of the third electrode facing the second electrode so as to elongate a cross-sectional shape of the electron beam horizontally within a main lens. However, the vertical diameter of the electron beam spot at the center of the viewing screen is greatly at large beam currents, and thereby resolution was degraded.

The reason that occurrence of halos is suppressed and brightness of halos is reduced as described above is the following. Electrons emitted from the cathode are attracted by the second electrode, and then travel toward the third electrode. Since the horizontally-elongated slit-shaped recess is superposed on the electron beam aperture in the end of the second electrode facing the first electrode, a distance between the cathode and a top or bottom edge of the electron-beam-transmissive portion of the second electrode is smaller than that between the cathode and a lateral edge of the electron beam aperture. Therefore, electron rays traveling in a vertical plane through the electron gun axis are attracted more strongly by the potential of the second electrode than electron rays traveling in a horizontal plane through the electron gun axis are, as a result the electron rays in the vertical plane travel in a region farther from the center axis of the electron beam aperture than the electron rays in the horizontal plane do, and consequently, the cross-sectional shape of the electron beam in the vicinity of the second electrode, i.e., the cross-sectional shape of the so-called cross-over, is vertically elongated. The amount of electrons attracted by the potential of the second electrode increases with decreasing distance from the edge of the electron beam aperture in the second electrode, the electron beam current density in the vertical plane decreases with increasing distance from the center axis of the electron beam aperture.

The electron lens formed between the second and third electrodes provides a focusing action in the vicinity of the second electrode and a diverging action in the vicinity of the third electrode. The diverging action is stronger in the horizontal direction than in the vertical direction, and therefore elongates the cross-sectional shape of the electron beam horizontally in the main lens.

FIGS. 8A and 8B are illustrations of cross-sectional shapes of electron beams in the main lens with and without the horizontally-elongated slit-shaped recess superposed on the electron beam aperture in the end of the second electrode facing the first electrode, respectively. In FIGS. 8A and 8B, H-H, V-V and D denote the horizontal direction, the vertical direction and a vertical overall diameter of an electron beam, respectively. D1 denotes a vertical diameter of a portion HD of high current density in the case of FIG. 8A, and D2 denotes a vertical diameter of a portion HD of high current density in the case of FIG. 8B.

For a fixed overall vertical diameter D of the electron beams, the case of FIG. 8A employing the horizontally-elongated slit-shaped recess in the end of the second electrode facing the first electrode provides a smaller vertical diameter of the high-current-density portion HD than the case of FIG. 8B does, i.e., D1<D2.

The smaller the vertical diameter of the electron beam, the less the electron beam is influenced by deflection defocusing while it traverses the deflection magnetic field, and consequently, brightness of halos of the electron beam spot occurring at the peripheries of the screen is made lower by employing the horizontally-elongated slit-shaped recess in the end of the second electrode facing the first electrode.

The electron beam spot diameter at the center of the viewing screen can be represented by the diameter of the crossover and the lens magnification of the main lens. In the case where the horizontally-elongated slit-shaped recess is provided in the end of the second electrode facing the first electrode, since the crossover diameter is elongated vertically, the electron beam spot diameter at the center of the viewing screen is elongated greatly in the vertical direction at large currents, resulting in deterioration of resolution.

It is one of objects of the present invention to provide a color cathode ray tube capable of providing displays with good resolution when viewed from proper distances, for example, about 1 m in the case of a television receiver set, and about 30 cm in the case of a color display device, by suppressing occurrence of halos of the electron beam spots formed by the electron beam impinging on the phosphor screen, and at the same time reducing brightness of halos.

To achieve the above object, in accordance with an embodiment of the present invention, there is provided a color cathode ray tube including an evacuated envelope having a panel, a neck and a funnel for connecting the panel and the neck, a phosphor screen formed on an inner surface of the panel for generating three colors by impingement of three electron beams, respectively, an electron gun housed in the neck for generating the three electron beams arranged in a line and focusing the three electron beams onto the phosphor screen, the electron gun comprising three in-line coplanar cathodes, a first electrode serving as an electron beam control electrode, a second electrode serving as an accelerating electrode, a third electrode serving as a focus electrode, and an anode serving as a final accelerating electrode arranged in the order named; and an electron beam deflection yoke mounted around a vicinity of a transitional region between the neck and the funnel for deflecting the three electron beams in a direction of an in-line arrangement of the three electron beams and a direction perpendicular thereto, wherein the first electrode is provided with three first-type electron beam apertures arranged in the direction of the in-line arrangement, each of the three first-type electron beam apertures being elongated in the direction of the in-line arrangement, an end of the second electrode facing the first electrode is provided with three second-type through-hole electron beam apertures arranged in the direction of the in-line arrangement, each of the three second-type through-hole electron beam apertures being superposed with a slit-shaped recess elongated in the direction of the in-line arrangement, and an end of the third electrode is provided with three non-axially-symmetric electron beam apertures arranged in the direction of the in-line arrangement, each of the non-axially-symmetric electron beam apertures having a major axis thereof in a direction perpendicular to the direction of the in-line arrangement.

With the above configurations, occurrence of halos at peripheries of the screen is suppressed without deteriorating resolution at the center of the screen at large currents, and thereby good resolution is obtained over the entire viewing screen when viewed from proper distances.

### BRIEF DESCRIPTION OF THE DRAWINGS

In the accompanying drawings, in which like reference numerals designate similar components throughout the figures, and in which:

FIGS. 1A-1D are schematic illustrations of a configuration example of an electron gun for explaining a first embodiment of the color cathode ray tube in accordance with the present invention;

FIG. 2 is a schematic perspective view illustrating the shape of the electron beam apertures made in the first electrode 2, which are applicable to the first and subsequent embodiments in accordance with the present invention;

FIG. 3 is a schematic perspective view illustrating the shape of the electron beam apertures made in an end of the second electrode facing the first electrode, in accordance with a second embodiment of the present invention;

FIG. 4 is a schematic perspective view illustrating the shape of the electron beam apertures made in the end of the second electrode facing the third electrode, which are applicable to each of the embodiments in accordance with the present invention;

FIG. 5 is a schematic perspective view illustrating the shape of an example of the electron beam apertures made in the end of the third electrode facing the second electrode, which is applicable to each of the embodiments in accordance with the present invention;

FIG. 6 is a schematic perspective view illustrating the shape of another example of the electron beam apertures made in the end of the third electrode facing the second electrode, which is applicable to each of the embodiments in accordance with the present invention;

FIG. 7 is a schematic perspective view illustrating the shape of an example of the electron beam apertures made in the end of the third electrode facing the fourth electrode, which is applicable to each of the embodiments in accordance with the present invention;

FIGS. 8A and 8B are illustrations of cross-sectional shapes of electron beams in the main lens with and without the horizontally-elongated slit-shaped recess superposed on the electron beam aperture in the end of the second electrode facing the first electrode, respectively;

FIGS. 9A to 9J illustrate the results obtained by computer simulation of the embodiments in accordance with the present invention, on the cross-sectional shapes of electron beams at the exits and entrances of the respective electrodes constituting the electron guns and an electron beam spot on the phosphor screen;

FIGS. 10A to 10J illustrate the results obtained by computer simulation of the conventional electron gun, on the cross-sectional shapes of electron beams at the exits and entrances of the respective electrodes constituting the conventional electron gun and an electron beam spot on the phosphor screen;

FIG. 11 is a side view of an example of the electron gun used in the color cathode ray tube in accordance with the present invention; and

FIG. 12 is a schematic cross-sectional view for explaining an example of an overall structure of the color cathode ray tube in accordance with the present invention.

### DETAILED DESCRIPTION OF THE PREFERRED EMBODIMENTS

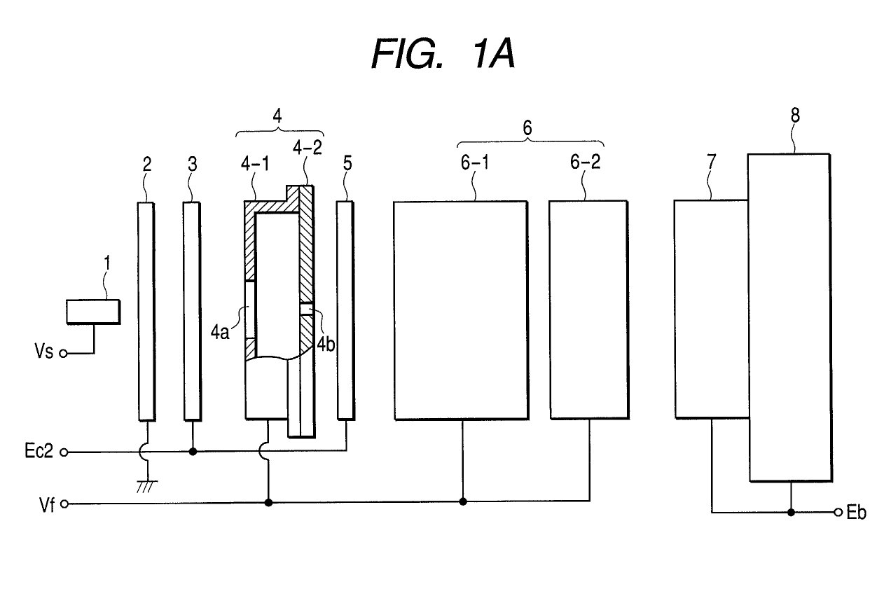

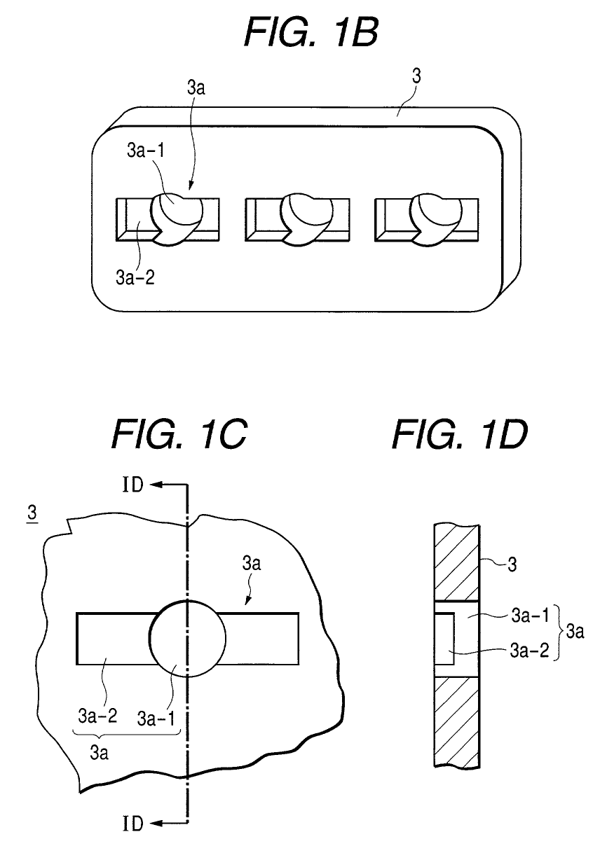

Embodiments of color cathode ray tubes in accordance with the present invention will be explained in detail by reference to the drawings. FIGS. 1A-1D are schematic illustrations of a configuration example of an electron gun for explaining a first embodiment of the color cathode ray tube in accordance with the present invention.

FIG. 1A illustrates an overall structure of an electron gun, FIG. 1B is a schematic perspective view of a second electrode, and FIGS. 1C and 1D illustrate a major portion of the second electrode. FIG. 1C is a plan view of an electron beam aperture in the second electrode as viewed from the first-electrode side thereof, and FIG. 1D is a cross-sectional view of the electron beam aperture taken along line ID-ID of FIG. 1C.

In the electron gun employed in the color cathode ray tube of this embodiment, as shown in FIG. 1A, cathodes (only one of which is shown) 1, the first electrode 2, the second electrode 3, the third electrode 4, the fourth electrode 5, a first member 6-1 of the fifth electrode 6, a second member 6-2 of the fifth electrode 6, and the sixth electrode 7 are arranged with arbitrary spacings therebetween.

The second member 6-2 of the fifth electrode 6 and the sixth electrode 7 forms a main lens therebetween, the second electrode 3 and the fourth electrode 5 are supplied with an accelerating voltage Ec2 (for example, in the range of from 400 V to 1,000 V), and the electrode 4, the first member 6-1 of the fifth electrode 6 and the second member 6-2 of the fifth electrode 6 are supplied with a focus voltage Vf (for example, in the range of from 6 kV to 9 kV). Vs denotes a signal voltage applied on the cathode 1. A shield cup 8 is electrically connected to the sixth electrode 7, and is supplied with an anode voltage Eb (for example, in the range of from 25 kV to 33 kV). A spacing between the first member 6-1 and the second member 6-2 of the fifth electrode 6 is provided for magnetic field generated for the purpose of velocity modulation of the electron beams to act efficiently on the electron beams, and it may be omitted.

As shown in FIGS. 1B-1D, an electron beam aperture 3a formed of a through-hole 3a-1 and a horizontally-elongated slit-shaped recess 3a-2 superposed on the through-hole aperture 3a-1 is provided on a surface of the second electrode 3 facing the first electrode 2. The second electrode 3 is made of a metal plate of thickness in the range of from about 0.3 mm to about 0.5 mm. The vertical dimension of the horizontally-elongated slit-shaped recess 3a-2 is smaller than the vertical diameter of the through-hole aperture 3a-1.

The third electrode 4 is composed of a cup-shaped electrode 4-1 and a plate electrode 4-2, for example, as shown in a partially broken-away side view in FIG. 1A, and its overall length is about 2 mm, for example.

A vertically elongated electron beam aperture for each of the three electron beams is made in an end of the third electrode 4 facing the second electrode 3, and a horizontally elongated electron beam aperture for each of the three electron beams is made in the first electrode 2. Since the vertically elongated electron beam aperture is made in the end of the third electrode 4 facing the second electrode 3, the strength of an electron lens formed in the vicinity of the third electrode 4, between the second electrode 3 and the third electrode 4, that is, a diverging lens, is weak in the vertical direction and is strong in the horizontal direction.

The strength of this diverging lens is controlled by adjusting the vertical and horizontal diameters of the vertically elongated apertures, or the thickness of the portions of the electrode formed with the vertically elongated apertures. In this embodiment, it is necessary to determine the specification of the lens such that the cross-sectional shape of the electron beam in the main lens is horizontally elongated at large electron beam currents.

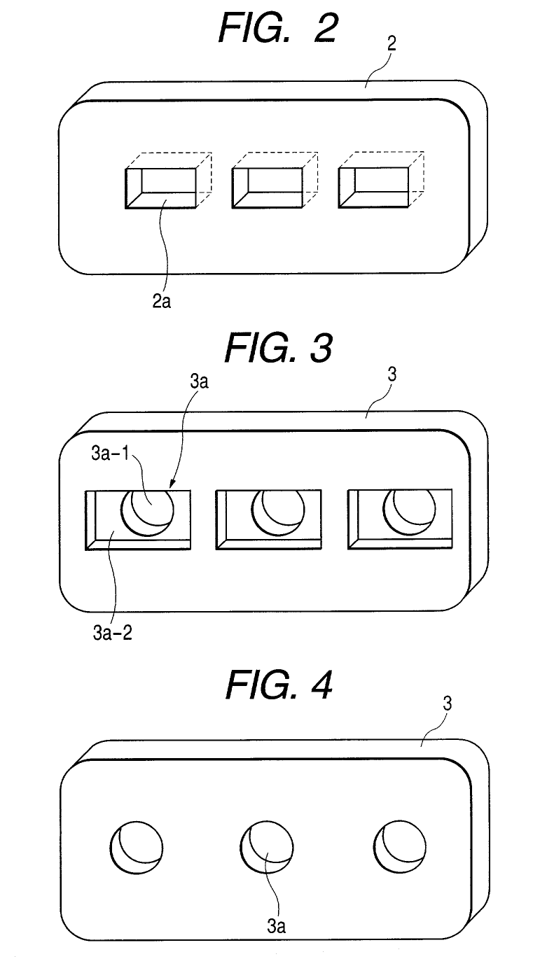

FIG. 2 is a schematic perspective view illustrating the shape of the electron beam apertures 2a made in the first electrode 2, which are applicable to the first and subsequent embodiments in accordance with the present invention.

Employment of the electron gun in accordance with this embodiment realizes a high-resolution color cathode ray tube capable of suppressing occurrence of halos at peripheries of the viewing screen without deteriorating resolution at the center of the viewing screen at large electron beam currents.

FIG. 3 is a schematic perspective view illustrating the shape of the electron beam apertures 3a made in an end of the second electrode 3 facing the first electrode 2, in accordance with a second embodiment of the present invention. As shown in FIG. 2, in this embodiment also, the electron beam apertures 2a in the first electrode 2 are horizontally elongated. Further, in the second embodiment, each of the electron beam apertures 3a made in the end of the second electrode 3 facing the first electrode 2 is provided with a horizontally-elongated slit-shaped recess 3a-2 having a vertical width larger than the diameter of a through-hole aperture 3a-1 the vertical diameter of the through-hole aperture 3a-1.

Employment of the electron gun in accordance with this embodiment realizes a high-resolution color cathode ray tube capable of suppressing occurrence of halos at peripheries of the viewing screen without deteriorating resolution at the center of the viewing screen at large electron beam currents.

FIG. 4 is a schematic perspective view illustrating the shape of the electron beam apertures 3a made in the end of the second electrode 3 facing the third electrode 4, which are applicable to each of the embodiments in accordance with the present invention, and the electron beam apertures 3a made in the end of the second electrode 3 facing the third electrode 4 are circular.

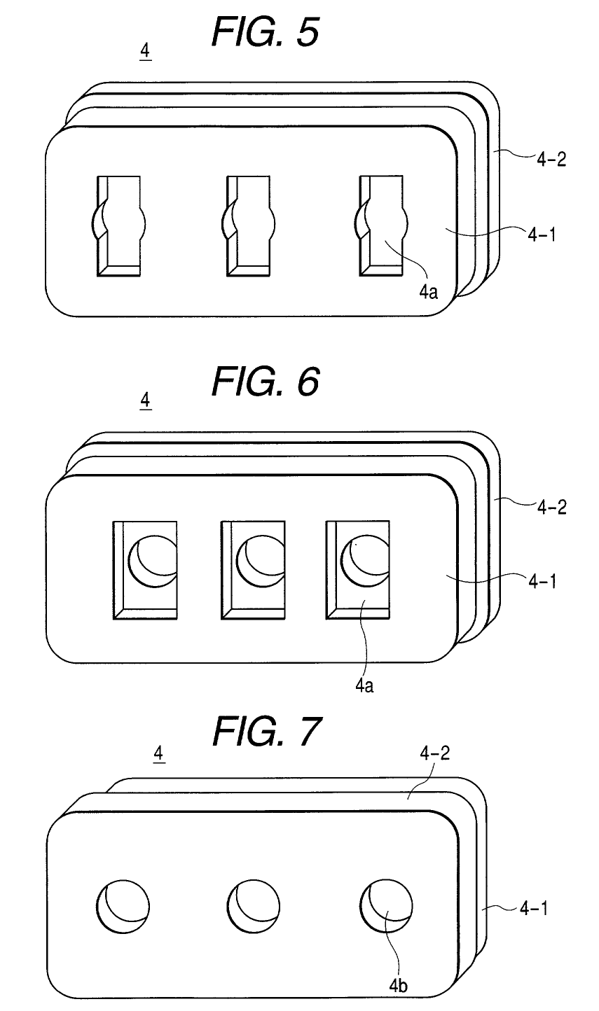

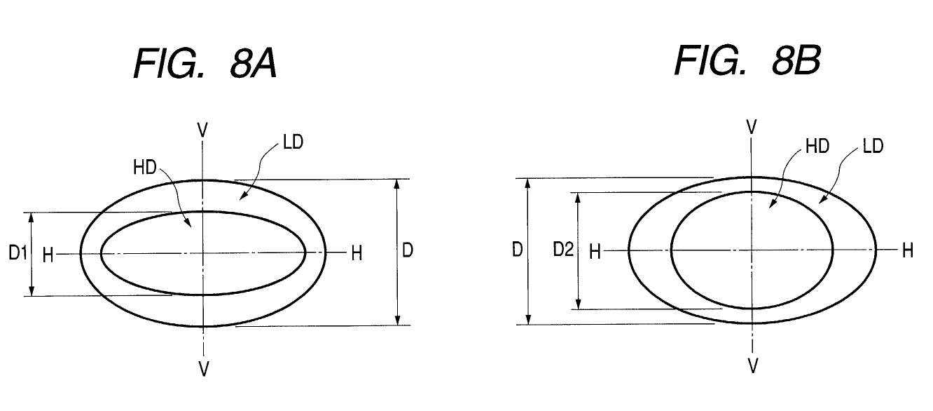

FIG. 5 is a schematic perspective view illustrating the shape of an example of the electron beam apertures 4a made in the end of the third electrode 4 facing the second electrode 3 (also see FIG. 1A), which is applicable to each of the embodiments in accordance with the present invention, and the electron beam apertures 4a made in the end of the third electrode 4 facing the second electrode 3 are of the shape of a keyhole.

FIG. 6 is a schematic perspective view illustrating the shape of another example of the electron beam apertures 4a made in the end of the third electrode 4 facing the second electrode 3, which is applicable to each of the embodiments in accordance with the present invention, and the configuration of each of the electron beam apertures 4a made in the end of the third electrode 4 facing the second electrode 3 is such that a vertically-elongated slit-shaped recess having a horizontal width larger than the diameter of the through-hole aperture 3a shown in FIG. 4.

FIG. 7 is a schematic perspective view illustrating the shape of an example of the electron beam apertures 4b (also see FIG. 1A) made in the end of the third electrode 4 facing the fourth electrode 5, which is applicable to each of the embodiments in accordance with the present invention, and the electron beam apertures 4b made in the end of the third electrode 4 facing the fourth electrode 5 is circular.

Employment of the electron guns having the structures in accordance with the embodiments explained in connection with FIGS. 4 to 7, respectively, realizes a high-resolution color cathode ray tube capable of suppressing occurrence of halos at peripheries of the viewing screen without deteriorating resolution at the center of the viewing screen at large electron beam currents.

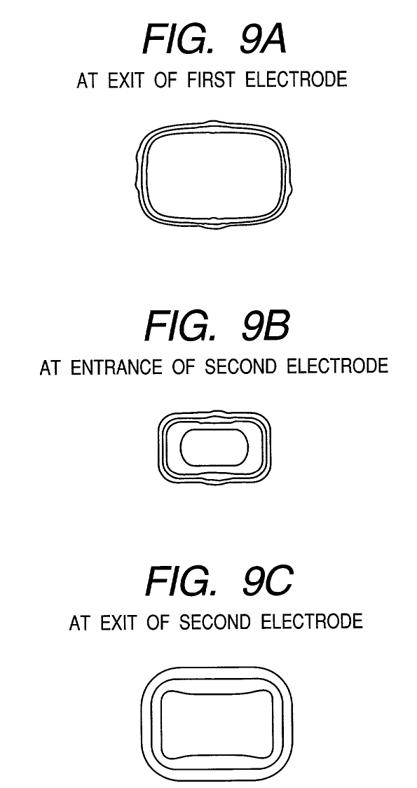

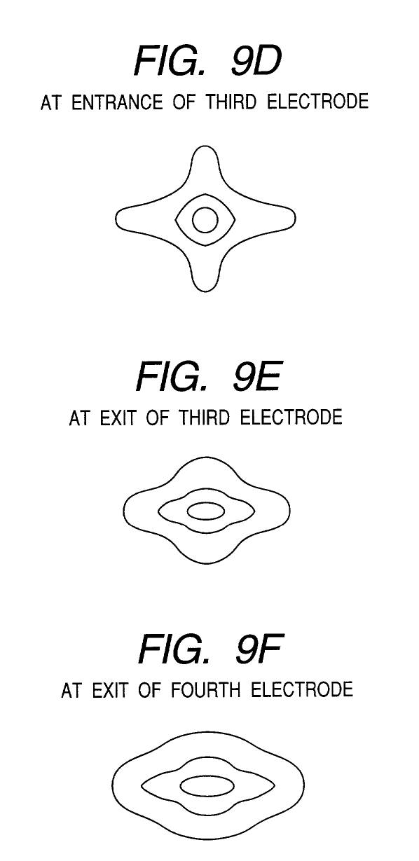

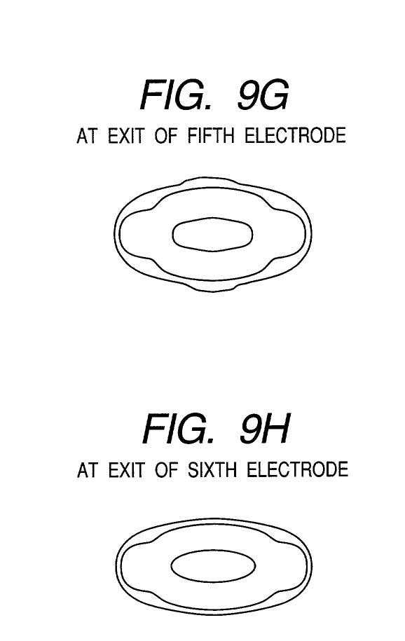

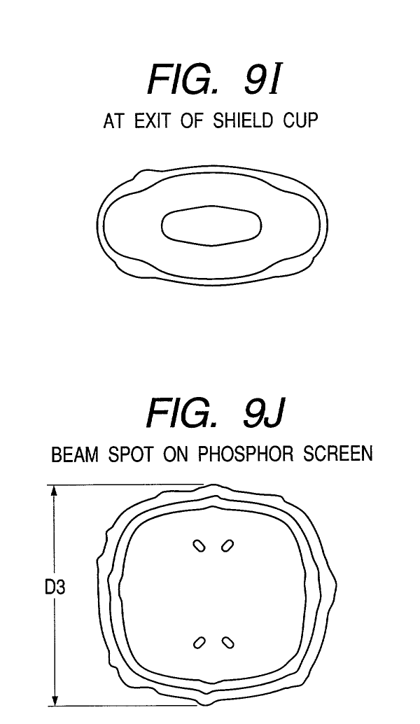

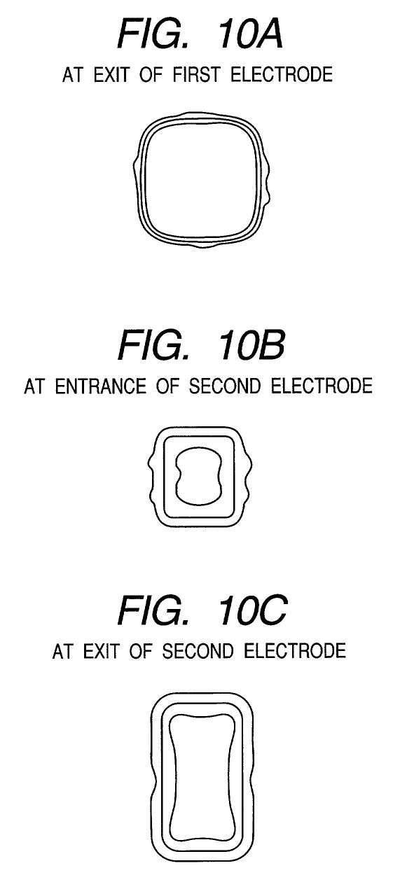

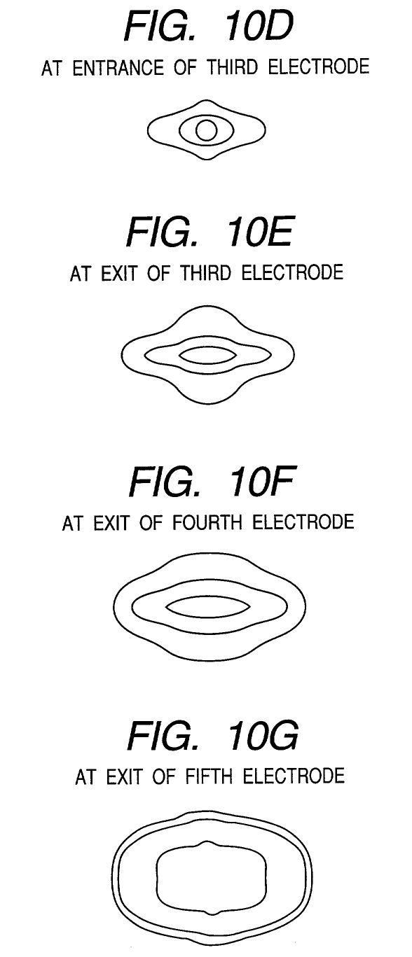

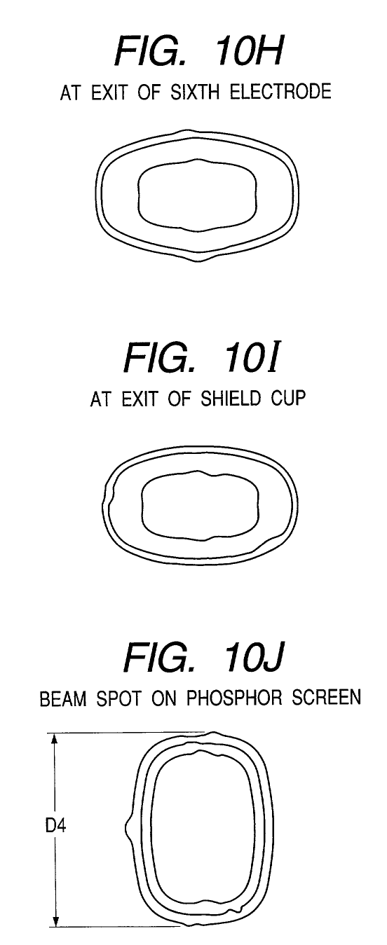

FIGS. 9A to 9J illustrate the results obtained by computer simulation of the embodiments in accordance with the present invention, on the cross-sectional shapes of electron beams at the exits and entrances of the respective electrodes constituting the electron guns and an electron beam spot on the phosphor screen. On the other hand, for comparison purposes, FIGS. 10A to 10J illustrate the results obtained by computer simulation of the conventional electron gun, on the cross-sectional shapes of electron beams at the exits and entrances of the respective electrodes constituting the conventional electron gun and an electron beam spot on the phosphor screen. FIGS. 9A to 9J correspond to FIGS. 10A to 10J, respectively, illustrating the cross-sectional shapes of the electron beams at the exits or entrances of the corresponding electrodes and the shapes of the electron beam spots on the phosphor screen.

FIG. 9A illustrate a cross-sectional shape of the electron beam at the exit of the first electrode 2, which is slightly elongated in the horizontal direction. FIG. 9B illustrates a cross-sectional shape of the electron beam at the entrance of the second electrode 3, FIG. 9C illustrates a cross-sectional shape of the electron beam at the exit of the second electrode 3, FIG. 9D illustrates a cross-sectional shape of the electron beam at the entrance of the third electrode 4, FIG. 9E illustrates a cross-sectional shape of the electron beam at the exit of the third electrode 4, FIG. 9F illustrates a cross-sectional shape of the electron beam at the exit of the fourth electrode 5, FIG. 9G illustrates a cross-sectional shape of the electron beam at the exit of the fifth electrode 6, FIG. 9H illustrates a cross-sectional shape of the electron beam at the exit of the sixth electrode 7, and FIG. 9I illustrates a cross-sectional shape of the electron beam at the exit of the shield cup 8. Consequently, the embodiments in accordance with the present invention provide a beam spot having a vertical diameter D3 as shown in FIG. 9J.

On the other hand, in the case of the conventional electron gun, the cross-sectional shapes of the electron beam are as shown in FIGS. 10A to 10I, and consequently, the shape of the electron beam spot on the phosphor screen is vertically elongated as shown in FIG. 10J. In the conventional electron gun, the cross-sectional shape of the electron beam at the exit of the second electrode 3 is vertically elongated as shown in FIG. 13C, and as a result the shape of the electron beam spot on the phosphor screen has a vertical diameter D4. This shows that, since D3<D4, the more highly valued vertical resolution than the horizontal resolution is lower in the conventional electron gun.

The diameter of the electron beam spot at the center of the viewing screen is represented by the diameter of the crossover and the magnification of the main lens, and therefore the vertical diameter of the electron beam spot at the center of the viewing screen is reduced by the amount in proportion to the reduction in the vertical diameter of the crossover.

A comparison was made between an actual color cathode ray tube employing the first electrode formed with three square electron beam apertures of 0.55 mm×0.55 mm and an actual color cathode ray tube employing the first grid electrode 2 formed with three rectangular electron beam apertures 2a of 0.5 mm in height and 0.6 mm in width (see FIG. 2) each providing an approximately same area of the beam aperture as that of the above square electron beam aperture. Significant reduction in the vertical diameter of the electron beam spot at the center of the viewing screen at large electron beam currents was confirmed in the case of the color cathode ray tube employing the first grid electrode formed with three rectangular electron beam apertures. In the above comparison, the areas of the electron beam apertures in the first electrodes were kept approximately equal to each other so as to maintain the same lifetime characteristics of the cathode ray tubes.

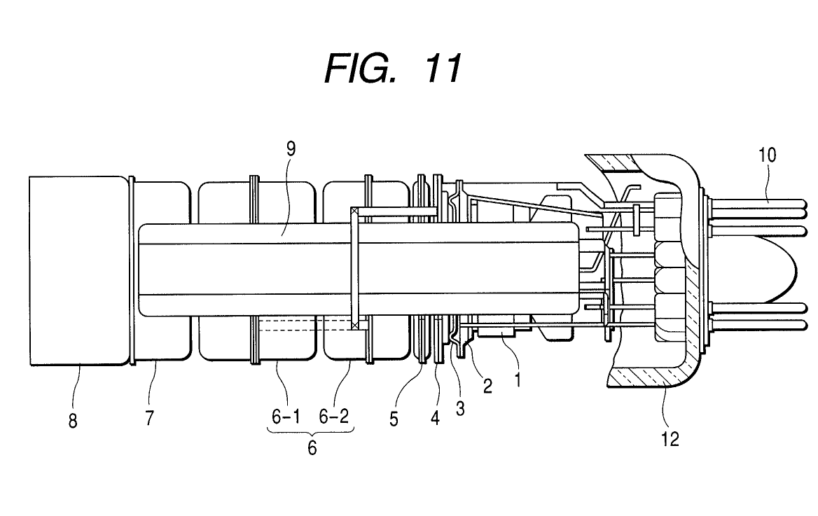

FIG. 11 is a side view of an example of the electron gun used in the color cathode ray tube in accordance with the present invention. The electron gun comprises cathodes 1, the first electrode 2, the second electrode 3, the third electrode 4, the fourth electrode 5, the fifth electrode 6 composed of the first member 6-1 and the second member 6-2, the sixth electrode 7, and the shield cup 8 arranged in the specified order with specified spacings therebetween and fixed on a pair of bead glasses 9. Signal voltages on the cathodes, voltages on the low-voltage electrodes, and the focus voltage on the focus electrode are supplied via stem pins 10, and the anode voltage applied on the sixth electrode 7 is supplied via spring members (not shown) attached to the shield cup 8 welded to the sixth electrode 7.

The first electrode 2 of the electron gun is formed with three electron beam apertures arranged in a line and each of the electron beam apertures has its long sides oriented in the direction of the arrangement of the three electron beam apertures.

Three electron beam apertures each superposed with a slit-shaped recess having its long sides oriented in the in-line direction of the arrangement of the three beam apertures are made in the end of the second electrode 3 facing the first electrode 2. Made in the end of the third electrode 4 facing the second electrode 3 is a non-axially-symmetric electron beam aperture for forming the cross-sectional shape of the electron beam therethrough into a shape having a major axis side in the in-line direction.

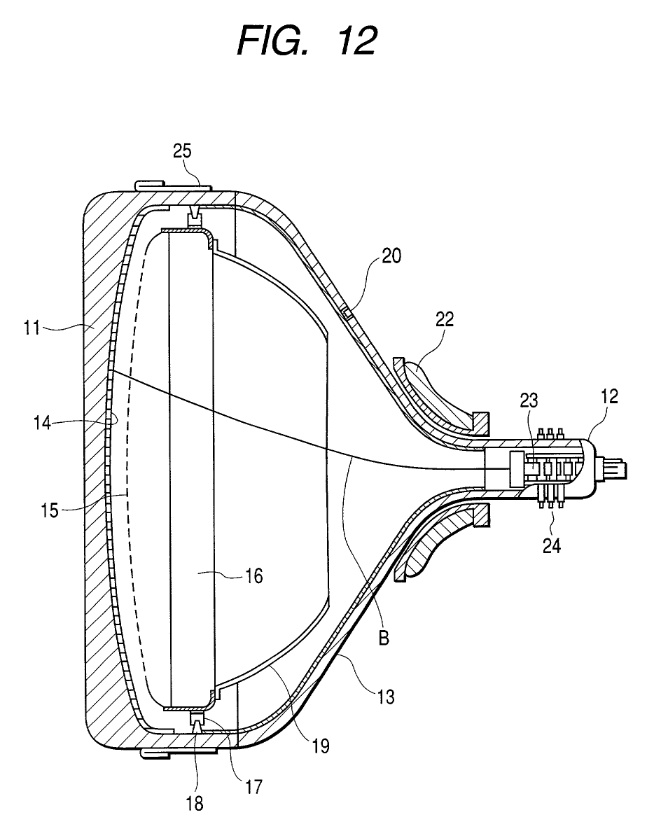

FIG. 12 is a schematic cross-sectional view for explaining an example of an overall structure of the color cathode ray tube in accordance with the present invention. A panel 11, a neck 12 and a funnel 13 form a vacuum envelope. A phosphor screen 14 is formed on the inner surface of the panel 11 by coating three-color phosphor material, and a shadow mask 15 serving as a color selection electrode is closely spaced from the phosphor screen 14. The shadow mask 15 is welded to a mask frame 16 which in turn is supported within the panel 11 by engaging suspension springs 17 welded to the outer wall of the mask frame 16 with studs 18 embedded in the inner wall of a skirt portion of the panel 11. A magnetic shield 19 is fixed to the electron gun side of the mask frame 16 for shielding external magnetic field (the Earth's magnetic field). A deflection yoke 22 is mounted around the transitional region between the approximately truncated-cone-shaped funnel 13 and the cylindrical neck 12 for deflecting three electron beams B (only one of which is shown) emitted from an electron gun 23 horizontally (in the in-line direction) and vertically (in the direction perpendicular to the in-line direction), and thereby reproducing an image on the phosphor screen 14.

Mounted around the neck 12 housing the electron gun 23 is an external magnetic device 24 for centering and converging the three electron beams and for adjusting color purity. In these color cathode ray tubes, to prevent breaking of the vacuum envelope called implosion and thereby insure safety, an annular implosion-preventing band 25 is tightly wound around the panel 11 with a specified force.

With the above electrode structure of the electron gun, the color cathode ray tube in accordance with this embodiment is capable of reducing a high-definition image with both occurrence of halos and brightness of halos reduced.

As explained above, the present invention provides color cathode ray tubes capable of exhibiting good resolution over the entire viewing screen when viewed from proper distances by suppressing occurrence of halos at peripheries of the screen and reducing brightness of halos without incurring deterioration of resolution at the center of the screen at large electron beam currents.

What is claimed is:

1. A color cathode ray tube including
an evacuated envelope having a panel, a neck and a funnel for connecting said panel and said neck,
a phosphor screen formed on an inner surface of said panel for generating three colors by impingement of three electron beams, respectively, an electron gun housed in said neck for generating said three electron beams arranged in a line and focusing said three electron beams onto said phosphor screen,
said electron gun comprising three in-line coplanar cathodes, a first electrode serving as an electron beam control electrode, a second electrode serving as an accelerating electrode, a third electrode serving as a focus electrode, and an anode serving as a final accelerating electrode arranged in the order named; and
an electron beam deflection yoke mounted around a vicinity of a transitional region between said neck and said funnel for deflecting said three electron beams in a direction of an in-line arrangement of said three electron beams and a direction perpendicular thereto,
wherein
said first electrode is provided with three first-type electron beam apertures arranged in said direction of said in-line arrangement, each of said three first-type electron beam apertures being elongated in said direction of said in-line arrangement,
an end of said second electrode facing said first electrode is provided with three second-type through-hole electron beam apertures arranged in said direction of said in-line arrangement, each of said three second-type through-hole electron beam apertures being superposed with a slit-shaped recess elongated in said direction of said in-line arrangement, and
an end of said third electrode is provided with three non-axially-symmetric electron beam apertures arranged in said direction of said in-line arrangement, each of said non-axially-symmetric electron beam apertures having a major axis thereof in a direction perpendicular to said direction of said in-line arrangement.

2. A color cathode ray tube according to claim 1, wherein a dimension of said slit-shaped recess measured in said direction perpendicular to said direction of said in-line arrangement is smaller than a dimension of said through-hole electron beam aperture measured in said direction perpendicular to said direction of said in-line arrangement.

3. A color cathode ray tube according to claim 1, wherein each of said non-axially-symmetric electron beam apertures is superposed with a slit-shaped recess elongated in said direction perpendicular to said direction of said in-line arrangement.
